(19) United States
(12) Patent Application Publication
(10) Pub. No.: US 2022/0096301 A1
(43) Pub. Date: Mar. 31, 2022

(54) Antimicrobial Lateral Transfer Apparatus And Method Of Use

(71) Applicant: Pelstar, LLC, McCook, IL (US)

(72) Inventor: John McAuley, Wildwood, FL (US)

(73) Assignee: Pelstar, LLC, McCook, IL (US)

(21) Appl. No.: 16/303,950

(22) PCT Filed: May 26, 2017
(86) PCT No.: PCT/US2017/034744

§ 371 Date: Nov. 21, 2018

Related U.S. Application Data
(60) Provisional application No. 62/342,643, filed on May 27, 2016.

(51) Int. Cl. A61G 7/10; A01N 59/16

(52) U.S. Cl. CPC A61G 7/1073; A01N 59/16; A61G 7/1074; A61G 7/103

(57) ABSTRACT

The invention comprises a patient transfer apparatus and method of use. The patient transfer apparatus in one form is a lateral transfer board having a board core, a two sided board covering, around which a tubular sheet rotates. The facing sides of the board covering and tubular sheet are coated with a material such as silicon to provide a low coefficient of friction. Two board handles are attached to each end. The materials of the lateral transfer board, including the board core, the sheets, and the plastic handles may have antimicrobial properties.

### CROSS-REFERENCE TO RELATED APPLICATIONS

This application claims priority from U.S. Provisional Patent Application Ser. No. 62/342,643, filed May 27, 2016.

### FIELD OF THE INVENTION

The invention relates to a lateral transfer apparatus for moving patients between locations.

### BACKGROUND OF THE INVENTION

There is often a need in hospitals, clinics, or for in-home care of patients to move a patient from one place to another without the patient contributing to this transfer on their own. Such a move takes place, for example, from a first bed to a second bed located next to it. Previously, it has been the practice to move such patients manually—simply lifting the patient (or a sheet underlying the patient) and carrying the patient from one place to another. This maneuver can be dangerous for all involved, uncomfortable for the patient, and difficult without a sufficient number of persons to lift and carry. The problem is complicated further if the first and second locations are at different heights.

There have been developed several types of lifting apparatus such as hoists and cranes which can assist in the lifting of a patient. However, such apparatus is complicated and costly, and just as importantly, is time consuming to position and operate.

In view of the above problems, a need was recognized for an improved patient transfer apparatus which could overcome the above problems and provide an easy to use, strong, antimicrobial device suitable for all types of situations encountered in emergency medical treatment.

The invention, consequently, relates to a lateral transfer board for patients who are to be moved using low force from a first location to a second location.

### SUMMARY OF THE INVENTION

In one form, the invention includes a lateral transfer board comprising a rectangular board comprising a pair of board sides and pair of board ends with an antimicrobial board cover comprising a sheet of material welded together at a seam, an antimicrobial additive, and a low friction outer side, substantially covering the surface of the board between the board ends and said low friction outer side facing away from said board.

The embodiment further comprises a tubular sheet of material having an antimicrobial property, which comprises a tubular sheet inner side facing said cover and a tubular sheet outer side facing away from said cover and said tubular sheet is wrapped around the board and in operative contact with the cover. The tubular sheet inner side has a low friction property wherein the interaction of said low friction outer side of the cover and the tubular sheet inner side results in a low friction coefficient such that the tubular sheet can rotate freely around the board.

The embodiment further comprises a pair of board handles formed of a plastic material with an antimicrobial additive, which are operatively attached to said board ends where each said board handle comprises a bottom edge proximate to said board end, a handle body, and a smooth opening substantially centered in said handle body. The tubular sheet is dimensioned so as to cover preferably two-thirds of said board between said handle bottom edges without extending over said handle bottom edges.

In another form, the invention includes a lateral transfer board, which can also be resilient, this board being encompassed by a two-sided material. The two-sided material is crafted from a material that can be connected at a seam with, e.g., radio-frequency welding. The two-sided material may also include an antimicrobial additive. The two-sided material is adapted to the shape of the board and attached to the board to prevent the two-sided material from sliding around the board. The inner side of the two-sided material is pressed against the board and provides a surface that facilitates adhesion to the board. The outer side of the two-sided material provides a low friction surface. A tubular sleeve is arranged around the board in contact with the outer side of the two-sided material. The interior side of the tubular sleeve comprises a low friction surface so that the tubular sleeve can readily rotate around the board. The exterior side of the tubular sleeve has a surface with a higher friction than the interior surface. The higher friction surface of the exterior side of the tubular sleeve allows a patient to lay upon the exterior side of the tubular sleeve without sliding off the board. The tubular sleeve may be crafted from a material capable of being welded with radio frequency welding, for example, at a seam. The tubular sleeve may also include an antimicrobial additive. The outer ends of the board are provided with handles which allow easily handling of the board. One advantage of the present invention is that it allows the transfer of a patient from one surface to another, where a gap exists between the two surfaces.

For example, a patient, lying in a bed, may have the lateral transfer board inserted underneath said patient, facilitated by the interaction between the two-sided material and the tubular sheet, where the tubular sheet rotates around the board as it is inserted under the patient. The structure of the lateral transfer board is such that the weight of patient may be supported over a gap, and held by individuals due to the structure and configuration of the board and board handles. The lateral transfer board may then be slid onto a second bed or surface, and then removed from under the patient in the same manner in which it was inserted. The handles may be crafted of a material which includes an antimicrobial additive.

In yet another form, the invention includes a patient transfer apparatus comprising: a rectangular board having at least, a pair of board sides, a pair of board ends, a pair of board handles attached to said board ends, each board handle comprising a handle body made from a plastic material, an antimicrobial additive, a bottom edge proximate to one board end, and a opening substantially centered in said handle body, a smooth and continuous board surface between said board ends, an antimicrobial board cover covering at least half of said board surface, having, material welded together at a seam, an antimicrobial additive, and a low friction antimicrobial board outer side facing away from said board surface, and a tubular sheet and wrapped around said board and in contact with said antimicrobial board cover but not substantially covering said pair of board handles, having, a material welded together at a seam, a tubular sheet inner side facing said low friction antimicrobial board outer side, wherein the interaction of the tubular sheet inner side the low friction antimicrobial board outer side results in a low friction coefficient such that said tubular sheet sheet can rotate freely around said board and antimicrobial board cover, and an antimicrobial additive.

In yet a further form, the invention includes a foldable patient transfer apparatus comprising a rectangular board having at least, a board core assembly having, at least two board cores, wherein each board core has a first end adapted to attach to a board handle and a second end adapted to attach to a board core coupler, and a smooth and continuous board surface between said first and ends, at least one board core coupler, wherein said board core coupler further comprises two sides, wherein at least one side is adapted to retain said second end, and a flexible area between said two sides operable as a hinge, at least one board core plug, a board handle attached to said first end, said board handle further comprising a handle body made from a plastic material, an antimicrobial additive, and a opening substantially centered in said handle body, an antimicrobial board cover covering at least half of said board surface, having, material welded together at a seam, an antimicrobial additive, and a low friction antimicrobial board outer side facing away from said board surface, and a tubular sheet and wrapped around said board and in contact with said antimicrobial board cover but not substantially covering said board handle, having, a material welded together at a seam, a tubular sheet inner side facing said low friction antimicrobial board outer side, wherein the interaction of the tubular sheet inner side the low friction antimicrobial board outer side results in a low friction coefficient such that said tubular sheet sheet can rotate freely around said board and antimicrobial board cover, and an antimicrobial additive.

In yet an even further form, the invention includes a method of transferring a patient in a lying position from the top surface of a first patient support to the top surface of a second patient support at a different height, and having a patient transfer apparatus including a lateral transfer board of the type described in any of the forms or embodiments herein spanning the distance between the top surfaces of the patient supports, the method comprising: (a) positioning the patient transfer apparatus to span the distance between the patient supports; (b) moving the patient onto the patient transfer apparatus by sliding the patient onto said tubular sheet outer surface causing said tubular sheet to rotate about said board; (c) supporting the head and legs of the patient; and (d) removing the patient transfer apparatus from under the patient when the patient is on the second support surface.

### BRIEF DESCRIPTION OF THE DRAWINGS

Other features in the invention will become apparent from the attached drawings, which illustrate certain embodiments of the apparatus of this invention, wherein:

FIG. 1 is a perspective view of one embodiment of a lateral transfer board according to the invention;

FIG. 2 is an exploded view illustrating constituent parts of the embodiment illustrated in FIG. 1;

FIG. 3 is a composite drawing showing multiple views of a board handle suitable for use with the embodiment shown in FIG. 1; and

FIG. 4 is a perspective view of another embodiment of a lateral transfer board according to the invention.

### DETAILED DESCRIPTION

While the following describes embodiments of this invention, it is understood that this description is to be considered only as illustrative of the principles of the invention and is not to be limitative thereof, as numerous other variations, all within the scope of the invention, will readily occur to others.

The term “adapted” shall mean sized, shaped, configured, dimensioned, oriented and arranged as appropriate. Herein, it will also be understood that in the figures, different embodiments may comprise the same or similar components. Where the same components are used in different embodiments, the same reference number may be used. Where components in different embodiments have a comparable structure, but are not necessarily common or identical parts, a similar number is used, but with a differing initial first digit, but common second and third digits. For example, and without limitation, board core 111 and 411 are examples of similar structures adapted for use in different embodiments of the present invention, but need not be interchangeable parts.

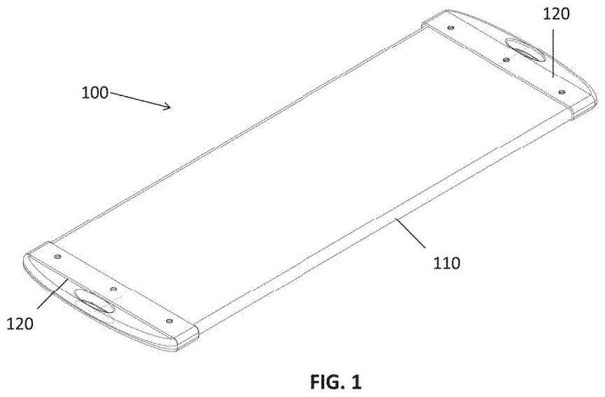

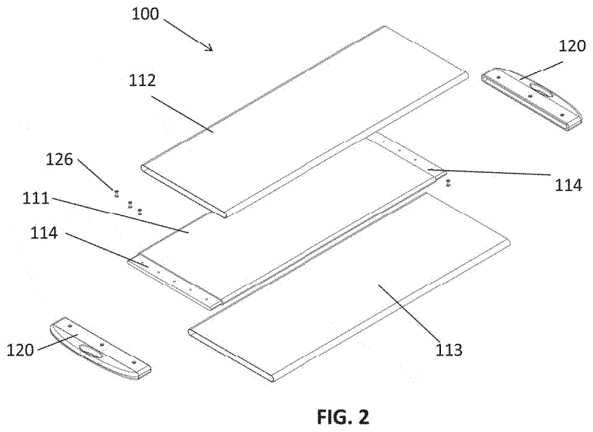

Referring now to FIG. 1, a lateral transfer board 100 for moving a patient is illustrated. Lateral transfer board 100 has board body 110 and board handles 120 attached to the ends. The constitutent parts of lateral transfer board 100 are shown in more detail in FIG. 2. Lateral transfer board 100 is illustrated in a parts exploded view, where board body 110 is illustrated in three parts. The board body has a board core 111 which may be conveniently made of a foam which has anti-fungus and anti-microbrial properties. One such foam is expanded polypropylene (EPP) available through injection molding techniques manufactured by ARPRO, which has offices at 1443 E. 12 Mile Road, Crown Office Village, Building J, Madison Heights, Mich. 48071. The foam material of board core 111 is merely one exemplary embodiment, and board core 111 may be made of other suitable materials which are capable of providing structural support and are capable of having an antimicrobial additive. As illustrated, board core 111 has recessed end portions 114 for the mounting of board handles 120. Board core 111 is covered by board cover 112.

Board cover 112 may be a sheet of material welded together at a seam and at one end. A welded seam, such as a seam welded by high energy or radio frequency welding provides advantages over stitched seams because a welded seam substantially prevents contaminates and germs from passing through the seam or being embedded in stitching. Further, materials that are capable of being welded are often easier to clean, thus providing a more easily sterilized or sanitized lateral transfer board. Board cover 112 may be crafted as a sealed enclosure with one open end, such as a bag. Board cover 112 may be crafted so that board core 111 fits inside the bag-shaped board cover 112. In some embodiments, board core 111 may fit snugly inside board cover 112 so that board cover 112 does not easily move around board core 111. Board cover 112 may have an inner side that comprises a high friction surface. Board cover 112 may have an outer side that comprises a low friction surface. When assembled, board cover 112 extends around board core 111 with the inner side, which comprises the high friction surface, facing board core 111. In some embodiments, board cover 112 may be constructed of nylon, with a taffeta, plain weave. The inner side of board cover 112 may be coated with thermoplastic polyurethane (TPU). The outside of board cover 112 may be coated with silicon. In other exemplary embodiments, the outside of board cover 112 may be coated with other compositions known in the art to provide a low friction surface. In a preferred embodiment, board cover 112 includes an antimicrobial additive, such as Ultra-Fresh, developed by Thomson Research Associates, located at 49 Gervais Drive, Toronto, Ontario, M3C1Y9, Canada. The antimicrobial additive may optionally be adapted to release silver ions. In further embodiments, board cover 112 may be flame retardant. After board core 111 is inserted into board cover 112, the open end of board cover 112 may conveniently be welded shut, or otherwise closed, although full closure is not a requirement.

A tubular sheet 113 is extends around board core 111 and board cover 112. In some embodiments, tubular sheet 113 may be constructed of nylon, with a plain weave. In a preferred embodiment, the outer side of tubular sheet 113 may be coated with thermoplastic polyurethane (TPU) and the inner side of tubular sheet 113 may be coated with silicon. In a preferred embodiment, tubular sheet 113 preferably includes an antimicrobial additive, such as Ultra-Fresh. Tubular sheet 113 has an inner side that comprises a low friction surface, such as may be created with a silicon coating. When the silicone-coated inner side of tubular sheet 113 is in contact with the silicone-coated outer side of board cover 112, a low friction interaction occurs. In a preferred exemplary embodiment, the static coefficient of friction in the interaction between board cover 112 and tubular sheet 113 may be less than 0.3N. Tubular sheet 113 may have an outer side that comprises a high friction surface. Tubular sheet 113 may be a tubular sheet of material welded together at a seam. A welded seam, such as a seam welded by high energy or radio frequency welding provides advantages over stitched seams because a welded seam substantially prevents contaminates and germs from passing through the seam or becoming embedded in the stitching. Further, materials that are capable of being welded are often easier to clean, thus providing a more sterile lateral transfer board. Tubular sheet 113 is wrapped around board core 111 with board cover 112 covering board core 111. The inner side of tubular sheet 113 is in operable contact with the outer side of board cover 112 such that the low friction surface of board cover 112 is facing the low friction surface of tubular sheet 113. This allows tubular sheet 113 to rotate around board core 111 and board cover 112, thus facilitating the transfer of a patient from one place to another. The higher friction outer side tubular sheet 113 acts to keep the patient on lateral transfer board 100 by providing grip to the patient's skin or clothing. Tubular sheet 113 is bounded by the edges of board handles 120, but does not extend over those handles 120.

Board handles 120 fit over and around recessed end portions 114, over the corresponding areas of board cover 112. The placement of board handles 120 over board cover 112 at the ends of board core 111 acts to keep board cover 112 stationary. The surfaces of board handles 120 are elevated slightly above the surface of board core 111 so that the edge of board handles 120 acts to keep tubular sheet 113 from overlapping board handles 120. The width of tubular sheet 113 is no larger than the distance between the edges of board handles 120. The width of tubular sheet 113 along with the edges of board handles 120 function to keep tubular sheet 113 in between the handles and away from the hand holds in the handles 120, thereby helping to prevent the spread of any containments from the patient. Board handles 120 may be secured to board core 111, through board cover 112, with mounting hardware 126. In some exemplary embodiments, board handles 120 may be secured to board core 111 with mounting hardware 126 comprised of screws or bolts. In a preferred embodiment, the mounting hardware 126 may comprised of a non-ferrous material. In an exemplary embodiment, the mounting hardware 126 material may be a non-magnetic material such as nylon, brass or aluminum. The use of Non-ferrous and non-magnetic materials allows for use of the lateral transfer board in diagnostic devices, such as devices for magnetic resonance imaging (MRI), and other situations where interference with the diagnostic device may be caused by ferrous or magnetic materials. Other methods of mounting handles to a board according to the invention will be readily apparent to those skilled in the art, and understood to be within the scope of the invention, including, but not limited to, other materials and mounting techniques which utilize non-ferrous materials, non-magnetic materials, or any other materials suitable for use in magnetic resonance imaging (MRI), including without limitation adhesives, press fits, or the use of shapes such as inwardly angled ridges on the inside of handles 120 that allow insertion during assemble, but resist removal during use.

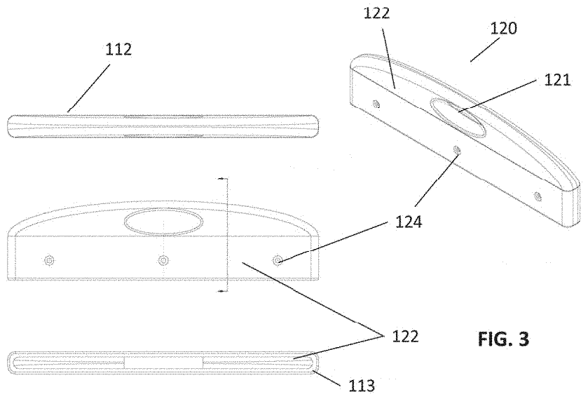

Referring now to FIG. 3, a board handle 120 is illustrated in a series of views. Board handle 120 is attached to the board core 111 by sliding over the end of the board core 111, as illustrated in FIG. 2. Board handle 120 may be made of plastic or similar materials. Board handle 120 may be treated with an antimicrobial additive, such as Biomaster 542, available from Addmaster Limited, located at Darfin House, Priestly Court, Staffordshire Technology Park, Stafford, ST18 OAR in the United Kingdom. Board handle 120 has a hollow board opening 122. Board opening 122 is adapted to accept one end of a board core 111, sheathed in board cover 112. Board handle mounting holes 124 are provided to secure board handle 120 to the board core 111 inserted into board opening 122. Mounting hardware, such as bolts or screws may be used to secure board handle 120 to a board core 111 through board handle mounting holes 124. In some embodiments, the mounting hardware may be made of a non-metallic material. In further embodiments, the mounting hardware may include rivets. In some embodiments, the mounting hardware may be conveniently made of a material to allow the board to be used in magnetic resonance imaging (MRI). In a preferred embodiment, the mounting hardware may comprised of a non-ferrous material. In an exemplary embodiment, the mounting hardware material may be a non-magnetic, non-ferrous material such as nylon, brass or aluminum. Other methods of mounting handles to a board according to the invention will be readily apparent to those skilled in the art, and understood to be within the scope of the invention, including, but not limited to, other materials and mounting techniques which utilize non-ferrous materials, non-magnetic materials, or any other materials suitable for use in magnetic resonance imaging (MRI). A handle opening 121 is formed into board handle 120. In some embodiments, handle opening 121 may conveniently have a width slightly larger than an average human hand width. In some embodiments, handle opening 121 may be between 3 inches and 7 inches wide. While a single handle opening 121 is illustrated, embodiments with multiple handle openings, or grips that do not comprise openings, are also envisioned.

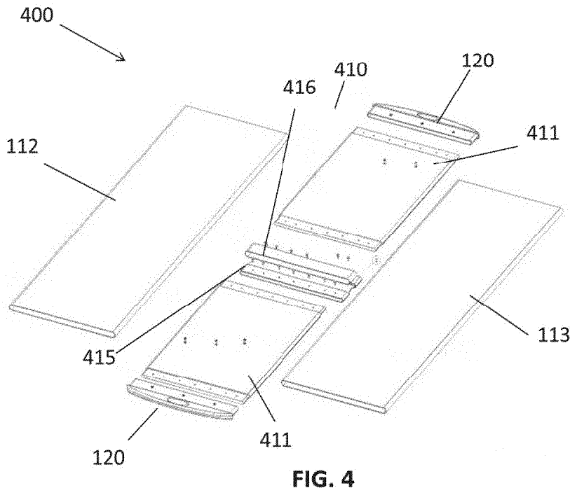

Referring now to FIG. 4, an alternate embodiment of the lateral transfer board of invention is illustrated. In this exemplary embodiment, lateral transfer board 400 may be foldable. In this exemplary embodiment, the board core 410 is comprised of an assembly, board core assembly 410, and the remaining portions of the board core are assembled in the manner described in reference to FIGS. 1, 2, and 3. Board core assembly 410 is comprised of two board cores 411, a board core coupler 415, and board core coupler plug 416. Board cores 411 may be made of the same material, such as an anti-bacterial or anti-fungal foam, as in the embodiments described with reference to FIGS. 1 and 2. Each board core 411 has two ends, one end for attaching to a board handle 120 and one end for attaching to board core coupler 415. In some embodiments, the board core halves may be reversible, meaning that either end could be attached to either board handles 120 or board coupler 415. Board core coupler 415 has two sides adapted to accept and retain the ends of board cores 411. One board core 411 may be inserted into each side of board core coupler 415. Board cores 411 may be secured to board core coupler 415 with mounting hardware. In a preferred embodiment, the mounting techniques and hardware may be the same as the embodiments illustrated and described with reference to FIGS. 1 and 2. Board core coupler 415 may have an area between the two sides that is thinner than the sides adapted to receive board cores 411. The thinner area may flex or bend, acting as a hinge so that the lateral transfer board may fold or bend at the thinner area of board core coupler 415. A board core coupler plug 416 fills the space between the outer diameter of the sides and the thinner area of board core coupler 415. The filling providing by board core coupler plug 416 allows for a flat surface when lateral transfer board 400 is unfolded. The filling action further provides strength and rigidity to lateral transfer board 400 so that when it is unfolded it can adequately support the weight of a patient. In a preferred exemplary embodiment, the remaining assembly of lateral transfer board 400, such as a board cover 112, a tubular sheet 113, and board handles 120 may be the same as in the embodiments described with reference to FIGS. 1 and 2.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of the appended claims.

1. A patient transfer apparatus comprising:
a rectangular board having at least,
a pair of board sides,
a pair of board ends,
a pair of board handles attached to said board ends, each board handle comprising
a handle body made from a plastic material,
an antimicrobial additive,
a bottom edge proximate to one board end, and
a opening substantially centered in said handle body,
a smooth and continuous board surface between said board ends,
an antimicrobial board cover covering at least half of said board surface, having,
material welded together at a seam,
an antimicrobial additive, and
a low friction antimicrobial board outer side facing away from said board surface, and
a tubular sheet and wrapped around said board and in contact with said antimicrobial board cover but not substantially covering said pair of board handles, having,
a material welded together at a seam,
a tubular sheet inner side facing said low friction antimicrobial board outer side, wherein the interaction of the tubular sheet inner side the low friction antimicrobial board outer side results in a low friction coefficient such that said tubular sheet sheet can rotate freely around said board and antimicrobial board cover, and
an antimicrobial additive.

2. The patient transfer apparatus of claim 1 wherein the seam of said antimicrobial board cover is welded using radio frequency welding.

3. The patient transfer apparatus of claim 1 wherein the seam of said tubular sheet is welded using radio frequency welding.

4. The patient transfer apparatus of claim 1 wherein the antimicrobial additive is adapted to release silver ions.

5. The patient transfer apparatus of claim 1 wherein said tubular sheet comprises one or more sheet edges contacting at least one said bottom edge.

6. The patient transfer apparatus of claim 1 wherein said opening is oval shaped.

7. The patient transfer apparatus of claim 1 wherein said opening is smooth to the touch.

8. The patient transfer apparatus of claim 1 wherein said tubular sheet and said board covering each have a color, and said tubular sheet color is lighter in shade than said board covering color.

9. The patient transfer apparatus of claim 8 wherein said tubular sheet color is gold and said board covering color is black.

10. The patient transfer apparatus of claim 1 wherein said rectangular board further comprises a foam material.

11. The patient transfer apparatus of claim 1 wherein said pair of board handles attached to said board ends further comprise non-ferrous mounting hardware.

12. The patient transfer apparatus of claim 11 wherein said mounting hardware is non-metallic.

13. The patient transfer apparatus of claim 1 wherein said pair of board handles attached to said board ends further comprise mounting hardware made of materials selected from the group consisting of brass, aluminum, and nylon.

14. A foldable patient transfer apparatus comprising:
a rectangular board having at least,
a board core assembly having,
at least two board cores, wherein each board core has a first end adapted to attach to a board handle and a second end adapted to attach to a board core coupler, and a smooth and continuous board surface between said first and ends,
at least one board core coupler, wherein said board core coupler further comprises two sides, wherein at least one side is adapted to retain said second end, and a flexible area between said two sides operable as a hinge,
at least one board core plug,
a board handle attached to said first end, said board handle further comprising
a handle body made from a plastic material,
an antimicrobial additive, and
a opening substantially centered in said handle body,
an antimicrobial board cover covering at least two-thirds of said board surface, having,
material welded together at a seam,
an antimicrobial additive, and
a low friction antimicrobial board outer side facing away from said board surface, and
a tubular sheet and wrapped around said board and in contact with said antimicrobial board cover but not substantially covering said board handle, having,
a material welded together at a seam,
a tubular sheet inner side facing said low friction antimicrobial board outer side, wherein the interaction of the tubular sheet inner side the low friction antimicrobial board outer side results in a low friction coefficient such that said tubular sheet can rotate freely around said board and antimicrobial board cover, and
an antimicrobial additive.

15. A method of transferring a patient in a lying position from the top surface of a first patient support to the top surface of a second patient support at a different height, and having a patient transfer apparatus including a rectangular board having at least,
a pair of board sides,
a pair of board ends,
a pair of board handles attached to said board ends, each board handle comprising
a handle body made from a plastic material,
an antimicrobial additive,
a bottom edge proximate to one board end, and
a opening substantially centered in said handle body,
a smooth and continuous board surface between said board ends,
an antimicrobial board cover covering at least two-thirds of said board surface, having,
material welded together at a seam,
an antimicrobial additive, and
a low friction antimicrobial board outer side facing away from said board surface, and
a tubular sheet and wrapped around said board and in contact with said antimicrobial board cover but not substantially covering said pair of board handles, having,
a material welded together at a seam,
a tubular sheet inner side facing said low friction antimicrobial board outer side, wherein the interaction of the tubular sheet inner side the low friction antimicrobial board outer side results in a low friction coefficient such that said tubular sheet can rotate freely around said board and antimicrobial board cover,
a tubular sheet outer surface facing away from said board surface, and an antimicrobial additive.
spanning the distance between the top surfaces of the patient supports, the method comprising:
(a) positioning the patient transfer apparatus to span the distance between the patient supports;
(b) moving the patient onto the patient transfer apparatus by sliding the patient onto said tubular sheet outer surface such that said tubular sheet rotates about said board;
(c) supporting the head and legs of the patient; and
(d) removing the patient transfer apparatus from under the patient when the patient is on the second support surface.
